(19) United States
(12) Patent Application Publication
(10) Pub. No.: US 2026/0143410 A1
(43) Pub. Date: May 21, 2026

(54) COMMUNICATIONS METHOD, TERMINAL DEVICE, AND NETWORK DEVICE

(71) Applicant: QUECTEL WIRELESS SOLUTIONS CO., LTD., Shanghai (CN)

(72) Inventor: Zheng ZHAO, Shanghai (CN)

(21) Appl. No.: 19/444,377

(22) Filed: Jan. 9, 2026

Related U.S. Application Data
(63) Continuation of application No. PCT/CN2024/104569, filed on Jul. 9, 2024.

(51) Int. Cl. H04W 48/02; H04W 48/08

(52) U.S. Cl. CPC H04W 48/02; H04W 48/08

(57) ABSTRACT

A communications method, a terminal device, and a network device are provided. One example communications methods includes: receiving a synchronization signal/physical broadcast channel block (SSB) from a network device, wherein the SSB comprises main information block (MIB) information, the MIB information indicates that access to a cell is barred.

### CROSS-REFERENCE TO RELATED APPLICATIONS

This application is a continuation of International Application No. PCT/CN2024/104569, filed on Jul. 9, 2024, the disclosure of which is hereby incorporated by reference in its entirety.

### TECHNICAL FIELD

The present application relates to the technical field of communications, and more specifically, to a communications method, a terminal device and a network device.

### BACKGROUND

In a communications system, terminal devices supporting different protocol versions may coexist. A synchronization signal/physical broadcast channel block (SS/PBCH block, or SSB) transmitted for a terminal device of a specific protocol version may be received by another terminal device operating with a different protocol version. As a result, the latter may erroneously use the received SSB for cell access and measurement. Accordingly, it is necessary to solve the problem of how to control cell access for terminal devices of different protocol versions.

### SUMMARY

The present application provides a communications method, a terminal device, and a network device. Descriptions of various aspects of the present application are provided as follows.

According to a first aspect, a communications method is provided. The method includes: receiving, by a terminal device, an SSB transmitted by a network device. The SSB includes MIB information. The MIB information is used to indicate that access to a cell is barred. The SSB is used by the terminal device to access the cell.

According to a second aspect, a communications method is provided. The method includes: transmitting, by a network device, a synchronization signal/physical broadcast channel block SSB to a terminal device. The SSB includes MIB information. The MIB information is used to indicate that access to a cell is barred. The SSB is used by the terminal device to access the cell.

According to a third aspect, a terminal device is provided. The terminal device includes a receiving unit, for receiving an SSB transmitted by a network device. The SSB includes MIB information. The MIB information is used to indicate that access to the cell is barred. The SSB is used by the terminal device to access the cell.

According to a fourth aspect, a network device is provided. The network includes a transmitting unit, for transmitting a synchronization signal/physical broadcast channel block SSB to a terminal device. The SSB includes MIB information. The MIB information is used to indicate that access to the cell is barred. The SSB is used by the terminal device to access the cell.

According to a fifth aspect, a terminal device is provided. The terminal device includes a processor, a memory, and a transceiver. The memory is configured to store one or more computer programs. The processor is configured to invoke the computer programs stored in the memory, and control the transceiver to receive or transmit a signal, to cause the terminal device to perform part or all of steps in the method described in the first aspect.

According to a sixth aspect, a network device is provided. The network device includes a processor, a memory, and a transceiver. The memory is configured to store one or more computer programs. The processor is configured to invoke the computer programs stored in the memory, and control the transceiver to receive or transmit a signal, to cause the network device to perform part or all of steps in the method described in the second aspect.

According to a seventh aspect, a communications system is provided. The communications system includes the terminal device and the network device as mentioned above. Optionally, the communications system further comprises other devices that interact with the terminal device and the network device.

According to an eighth aspect, a computer-readable storage medium is provided, the computer-readable storage medium storing a computer program. The computer program causes the terminal device and the network device to perform part or all of steps in the methods described in the above aspects.

According to a ninth aspect, a computer program product is provided, the computer program product including a non-transitory computer-readable storage medium storing a computer program. The computer program is operable to cause the terminal device and the network device to perform part or all of steps in the methods described in the above aspects. Optionally, the computer program product includes a software installation package.

According to a tenth aspect, a chip is provided, the chip including a memory and a processor. The processor is configured to invoke and execute a computer program stored in the memory to implement part or all of steps described in the methods of the above aspects.

In the embodiments of the present application, when the MIB information in the SSB indicates that access to the cell is barred, a terminal device that supports a lower protocol version will not access the cell, whereas a terminal device that supports a higher protocol version may further determine, based on relevant content in the MIB information, whether to access the cell, and access the cell via the SSB when access is determined to be allowed. In this way, access to a cell for terminal devices of different protocol versions is manageable. Therefore, when detecting an SSB intended to be transmitted to a terminal device that supports a higher protocol version, a terminal device that supports a lower protocol version will not erroneously use the SSB that does not belong to it for access and measurement, thereby avoiding degradation in subsequent communications quality or even connection interruption.

### BRIEF DESCRIPTION OF THE DRAWINGS

FIG. 1 is a schematic diagram of a wireless communications system to which embodiments of the present application may be applied.

FIG. 2 is a schematic flowchart of a communications method according to an embodiment of the present application.

FIG. 3 is a schematic block diagram of a terminal device according to an embodiment of the present application.

FIG. 4 is a schematic block diagram of a network device according to an embodiment of the present application.

FIG. 5 is a schematic block diagram of a communications apparatus according to an embodiment of the present application.

### DETAILED DESCRIPTION OF THE EMBODIMENTS

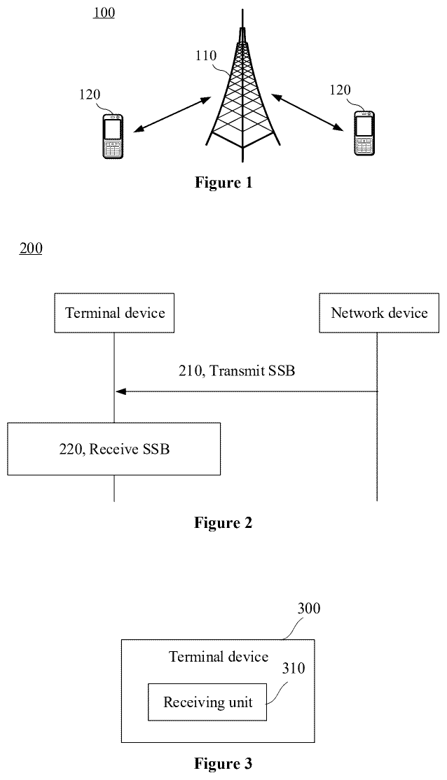

The following description will describe the technical solutions of the present application with reference to the accompanying drawings. For ease of understanding, the communications terms and communications processes that may be involved in the embodiments of the present application will first be introduced with reference to FIG. 1.

### Wireless Communications System

FIG. 1 is a schematic diagram illustrating a wireless communications system 100 applied to the embodiments of the present application. The wireless communications system 100 may include a network device 110 and terminal devices 120. The network device 110 may be a device that communicates with the terminal device 120. The network device 110 may provide network coverage for a specific geographical area and communicate with the terminal devices 120 located within the coverage area. The terminal device 120 may access a network (e.g., a wireless network) via the network device 110. Optionally, the wireless communications system 100 may also include other network entities, such as a network controller, a mobility management entity, etc., which are not specifically limited in the embodiments of the present application.

It should be understood that the technical solutions in the embodiments of the present application can be applied to various communications systems, such as a fifth-generation (5G) system or new radio (NR), a long-term evolution (LTE) system, an LTE frequency division duplex (FDD) system, an LTE time division duplex (TDD) system, and so on. The technical solutions is the present application can also be applied to a future communications system, such as a sixth-generation (6G) mobile communications system, a satellite communications system, and the like.

The terminal device in the embodiments of the present application may also be referred to as user equipment (UE), an access terminal, a user unit, a user station, a mobile station, a mobile terminal (MT), a remote station, a remote terminal, a mobile device, a user terminal, a terminal, a wireless communications device, a user agent, or a user device. The terminal device in the embodiments of the present application refers to a device that provides voice and/or data connectivity to users and can be used for connecting people, things, and machines, such as a handheld device, an in-vehicle device, and the like with wireless connectivity. In the embodiments of the present application, the terminal device may be a mobile phone, a tablet computer (Pad), a laptop, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Optionally, the terminal device may serve as a base station. For example, the terminal device may serve as a scheduling entity, providing sidelink signals between terminal devices in vehicle to everything (V2X) or device to device (D2D) communications. For instance, a cellular phone and a vehicle may communicate with each other using sidelink signals. A cellular phone may directly communicate with a smart home device without relaying signals by a base station.

In the embodiments of the present application, the network device may be a device configured to communicate with a terminal device. The network device may be, for example, an access network device or a radio access network device. For instance, the network device may be a base station. The base station may broadly cover, or be replaced with, various terms such as: a NodeB, an evolved NodeB (eNB), a next generation NodeB (gNB), a relay station, an access point, a transmitting and receiving point (TRP), a transmitting point (TP), a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof.

### Radio Resource Control (RRC) State and Mobility Management

Currently, the protocol defines three RRC states for a terminal device: an RRC connected (RRC_connected) state, an RRC idle (RRC_idle) state, and an RRC inactive (RRC_inactive) state.

The RRC connected state refers to the state in which a terminal device remains after completing the random access procedure and before performing RRC release. An RRC connection exists between the terminal device and the network device (e.g., the access network device). In the RRC connected state, the terminal device can perform data interaction with the network device, such as downlink data transmission and/or uplink data transmission. Alternatively, the terminal device may also perform transmission of terminal device-specific data channels and/or control channels with the network device, to transmit specific information or unicast information for the terminal device.

In the RRC connected state, the network device can locate the terminal device at the cell level, that is, the network device can identify the cell to which the terminal device belongs. After the terminal device moves to a different location, e.g., moving from one cell to another, the network device can control the terminal device to perform a cell handover. Therefore, mobility management for the terminal device in the RRC connected state can include cell handover. Furthermore, the mobility management for the terminal device in the RRC connected state can be controlled by the network device, and accordingly, the terminal device can perform a handover to a designated cell according to the instructions issued by the network device.

The RRC idle state refers to the state in which a terminal device resides in a cell but has not performed random access. The terminal device typically switches to the RRC idle state after power-on or after an RRC release. In the RRC idle state, there is no RRC connection between the terminal device and the network device (e.g., the serving network device), the network device does not store the context of the terminal device, and no connection is established between the network device and the core network for the terminal device. When the terminal device needs to transition from the RRC idle state to the RRC connected state, an RRC connection establishment procedure must be initiated.

In the RRC idle state, the core network (CN) can send a paging message to the terminal device, that is, the paging procedure can be triggered by the CN. Optionally, the paging area can also be configured by the CN. In some cases, when a terminal device in the RRC idle state changes its location (e.g., moving from one cell to another), the terminal device can initiate a cell reselection procedure. In other cases, when a terminal device in the RRC idle state needs to access a cell, the terminal device can initiate a cell selection procedure. In other words, mobility management for the terminal device in the RRC idle state includes cell reselection and/or cell selection.

The RRC inactive state is defined to reduce air interface signaling, enable fast recovery of wireless connections, and allow quick restoration of data services. The RRC inactive state is between the connected state and the idle state. The terminal device has previously in the RRC connected state, then released the RRC connection with the network device, while the network device retains the context of the terminal device. Furthermore, the connection established between the network device and the core network for the terminal device has not been released. That is, the user plane and control plane bearers between the RAN and the CN are still maintained, i.e., there exists a CN-NR connection.

In the RRC inactive state, the RAN can send a paging message to the terminal device, that is, the paging procedure can be triggered by the RAN. The paging area based on the RAN is managed by the RAN, and the network device can determine that the location of the terminal device is based on the RAN paging area level.

In some cases, when a terminal device in the RRC inactive state changes its location (e.g., moving from one cell to another), the terminal device can initiate a cell reselection procedure. In other cases, when a terminal device in the RRC inactive state needs to access a cell, the terminal device can initiate a cell selection procedure. In other words, mobility management for the terminal device in the RRC inactive state can include cell reselection and/or cell selection.

### SSB

The SSB plays an important role in the initial access, synchronization, and acquisition of broadcast information of the cell by the terminal device. For example, the SSB carries the cell identity (ID), facilitates time and frequency synchronization, indicates symbol-level/slot-level/frame timing, supports measurement of beam signal strength/signal quality, and supports measurement of cell signal strength/signal quality. The measurement of cell signal strength/signal quality may include, for example, radio resource management (RRM) measurement or channel state information (CSI) measurement. The measurement of beam signal strength/signal quality may be used for performing beam selection, beam failure detection, beam failure recovery and so on.

The SSB includes a primary synchronization signal (PSS), a secondary synchronization signal (SSS), a physical broadcast channel (PBCH), and a demodulation reference signal (DMRS). The PBCH carries master information block (MIB) information. The MIB information is transmitted via the PBCH. The synchronization signals in the SSB, such as the PSS and SSS, as well as the PBCH DMRS, ensure that the terminal device can effectively receive the MIB information under different transmission environments. The MIB information is key broadcast information that ensures the terminal device can successfully access and use the network. The MIB information provides basic configuration parameters and synchronization information for the system, and serves as one of the fundamental elements for network operation. Based on the MIB information, the terminal device can obtain basic system information and perform subsequent connection and communications operations.

Typically, the MIB information includes information about a control resource set (CORESET) and a search space for a physical downlink control channel (PDCCH), which is of Type-0 format and is used to carry a system information block (SIB), e.g., SIB1. The terminal device can determine the PDCCH based on the MIB information, and further obtain SIB1 on a corresponding physical downlink shared channel (PDSCH) based on the PDCCH.

The CORESET can be understood as a set of resources used for transmitting downlink control information (DCI), and may also be referred to as a control resource region or a physical downlink control channel (PDCCH) resource set. The PDCCH is used to carry downlink control information (DCI) and is transmitted by a network device to a terminal device. DCI carried by the PDCCH, depending on distinct formats, can indicate different control information to the terminal device, e.g., downlink scheduling information, uplink scheduling information, slot format indication information, or the like. Currently, the resources of the PDCCH are defined by a CORESET and a search space. In some implementations, information such as bandwidth occupied by the PDCCH in the frequency domain and the number of symbols occupied by the PDCCH in the time domain may be encapsulated in the CORESET. Correspondingly, information such as the starting symbol index occupied by the PDCCH and the monitoring periodicity of the PDCCH may be encapsulated in the search space.

In addition, the MIB information may further include the following information: a system frame number (SFN), which is used to indicate the index of the current system frame for frame synchronization; carrier frequency and bandwidth information, which is used to provide information on spectrum usage to assist the terminal device in connecting to the currently used frequency resources; subcarrier spacing (SCS) configuration, which is used to indicate the subcarrier spacing in the frequency domain, for example, supporting different subcarrier spacings such as 15 kHz, 30 kHz, 60 kHz, 120 kHz, and 240 kHz; information on the SSB periodicity, which is used to assist the terminal device in detecting synchronization signals within a specific time window; and parameters such as wireless port configuration and power control.

The MIB information includes basic configuration parameters required by the RAN. The MIB information is the first step for a terminal device to access the network. After receiving and decoding the MIB information, the terminal device can obtain system information as described above, thereby correctly accessing the network and performing communication. The SFN and other physical layer parameters in the MIB information can be used by the terminal device for time and frequency synchronization, and for decoding other more detailed system information blocks, e.g., SIB1. SIB1 provides key information required for the terminal device during initial access and normal operation, enabling the terminal device to correctly perform synchronization, select an appropriate cell, initiate random access, and obtain basic configuration parameters of the network. Based on SIB1, the terminal device can efficiently communicate with the network device to ensure a stable and reliable connection. SIB1 includes key system information required for the terminal device to access the network, such as public land mobile network (PLMN) information, cell selection information, time and frequency information, access parameters, power control information, cell broadcast information, public warning information, and other information. The other information may include, for example, cell access restrictions, registration area-related information, and the like. It can be seen that the MIB information serves as the basis for broadcasting system information and enables the terminal device to acquire the most critical system configuration and physical layer information at the initial stage.

The MIB information may be encoded using, for example, 24 bits. The information carried in these 24 bits is used by the terminal device for initial network access and configuration. The 24 bits in the MIB information may include, for example, an SFN field, a subcarrier spacing (subCarrierSpacingCommon) field, an SSB subcarrier offset (ssb-SubcarrierOffset) field, a PDCCH SIB1 configuration (pdcch-ConfigSIB1) field, a cell barred (CellBarred) field, an intra-frequency reselection field, a DMSR position (dmrs-TypeA-Position) field, and a reserved bit. The content of the main fields in the MIB bit domain may refer to Table 1 as an example.

TABLE 1

| | Number | |
|---|---|---|
| MIB bit domain | of bites | Definition |
| SFN | 6 bites | Indicating the higher 6 bits of SFN, the lower 4 bits are |
| | | implicitly indicated through the periodic transmission of the |
| | | PBCH, allowing representation of 64 different frame |
| | | numbers. |
| subCarrierSpacingCommon | 2 bites | Indicating subcarrier spacing for SIB1, e.g., 15 kHz, 30 kHz, |
| | | 60 kHz, or 120 kHz. |
| ssb-SubcarrierOffset | 4 bites | Indicating a frequency position of the SSB relative to the |
| | | carrier, and this field may indicate whether the SSB is a CD |
| | | SSB or an NCD SSB. |
| pdcch-ConfigSIB1 | 8 bites | Indicating CORESET information corresponding to SIB1, |
| | | this field may share certain bits with the ssb-PositionsInBurst |
| | | field in the MIB information, and these bits indicate distinct |
| | | content under different conditions. |
| CellBarred | 1 bite | Indicating whether the cell is barred from access. When set |
| | | to “barred,” the cell is prohibited from access. |
| Intra-frequency Reselection | 1 bite | Indicating whether the UE is allowed to perform intra- |
| | | frequency reselection. When set to “allowed,” intra- |
| | | frequency reselection is allowed. |
| dmrs-TypeA-Position | 1 bite | Indicating a position of a first downlink DM-RS. |
| Reserved | 1 bite | Reserved for future use. |

The main function of the cellBarred field in the MIB information is to control and manage cell access permissions. By setting this field, the network can effectively guide the behavior of terminal devices, optimize resource management, and perform cell-level maintenance or load control when necessary. This mechanism plays an important role in ensuring network stability and service quality.

As shown in Table 1, the CellBarred field is used to indicate whether the cell is barred from access by terminal devices. For example, when the field is set to barred, it indicates that the cell is barred from access. When the field is set to notBarred, it indicates that the cell is not barred from access.

When the cell is barred from access, all terminal devices that receive the MIB information will recognize that the cell is not allowed for access, thereby avoiding attempts to connect to the cell. This scenario is typically used for network maintenance, load control, or temporarily shutting down a cell. By broadcasting the cell barred information, the network device can guide terminal devices to search for other available cells. For terminal devices, when the current cell is barred, they can automatically search for and attempt to access other non-barred cells. By explicitly informing terminal devices that a cell is barred from access, unnecessary repeated access attempts to the cell can be avoided, thereby saving power consumption and improving access efficiency.

During cell-level network maintenance or software upgrades, the operator may temporarily set the CellBarred field to barred to prevent terminal devices from accessing the cell, thereby ensuring the smooth execution of maintenance tasks. In some cases, a cell may become overloaded and require a temporary restriction on new terminal device access. By setting the CellBarred field to barred, the network device can guide newly arriving terminal devices to access other cells with lower load. During some emergency situations or disaster recovery periods, the operator may temporarily shut down specific cells to manage resources or optimize network performance.

In a 5G NR system, the CellBarred field can typically be configured and broadcast via a network management system (NMS) or other configuration tools. Operators can dynamically adjust the value of the CellBarred field based on real-time network conditions and requirements to achieve flexible network management and optimization.

The MIB information is periodically broadcast in the PBCH to ensure that all terminal devices can timely receive these critical system information. After being powered on, the terminal device needs to access the network and be capable of receiving and transmitting data, which requires execution of the initial access procedure. During the access procedure, the terminal device needs to perform sweeping on synchronization signals, decode the PBCH and SIB1 to perform cell search and selection.

After being powered on, the terminal device first sweeps different frequency bands to search for synchronization signals, such as the PSS and the SSS. By decoding the synchronization signals, the terminal device obtains the physical layer identifier (PCI) of the cell and information about the frame structure, thereby achieving time and frequency synchronization. Based on the information from the synchronization signals, the terminal device determines the time and frequency resource location of the PBCH and receives and decodes the PBCH. After decoding the PBCH, the terminal device obtains the MIB information and extracts from the 24 bits of the MIB the SFN, subcarrier spacing of the SSB, higher-layer parameters, and other configuration information. After decoding the SIB1, the terminal device can obtain more detailed system information, such as the cell configuration and random access channel (RACH) configuration. Subsequently, the terminal device performs a random access procedure, i.e., the RACH procedure, thereby achieving uplink synchronization and exchanging terminal identifier information with the network device. For example, the network device may notify the terminal device of a cell-radio network temporary identifier (C-RNTI), and the terminal device may report its identifier such as a SAE temporary mobile subscriber identity (S-TMSI) or an international mobile subscriber identity (IMSI). The network device sends an RRC connection setup message to the terminal device and instructs the terminal device to switch to the radio resource control (RRC) connected state. Through the initial access procedure, the terminal device can successfully access the network and perform reliable data transmission.

In every mobile communications system, the standards being implemented are continuously evolving and improving, resulting in the emergence of new protocol versions. As a result, terminal devices of multiple protocol versions may coexist and operate within the same system. The wireless system of a higher protocol version introduces improvements compared to previous versions. When a serving cell supports a wireless system of a higher protocol version, issues may arise during certain stages of communications when a terminal device with a lower protocol version attempts to access the cell. For example, improvements and adjustments may have been made to the SSB in the higher protocol version, and a terminal device operating under a lower protocol version may not be able to recognize or utilize the SSB as defined in the newer version.

In a carrier aggregation (CA) scenario, in addition to the primary cell (PCell), the system may configure one or more secondary cells (SCells), which together provide higher data rates and improved coverage for the user. An SCell may be configured not to transmit an SSB. Such an SCell may be referred to as an SSB-less cell, provided that the SCell is co-located with a special cell (sPCell) or another SCell operating on the same frequency. When the terminal device is already synchronized with another cell that is co-located with the SSB-less cell, then the terminal device may perform communications on the SSB-less cell. Typically, the terminal device may perform synchronization and initial access on the SCell based on the SSB transmitted by the PCell. After completing synchronization and initial access to the SCell based on the SSB on the PCell, the SCell may be configured and activated through RRC signaling or a medium access control (MAC) control element (CE), thereby enabling flexible CA and cell management. For example, the SCell may be added, modified, or released through RRC connection reconfiguration. Alternatively, the SCell may be activated or deactivated via a MAC CE. In this way, when spectral resources are limited, unnecessary SSB transmissions can be reduced, thereby improving spectral efficiency and reducing power consumption at both the network device and the terminal device, particularly the power consumption of the network device.

Although an SCell may be configured not to transmit an SSB, in some specific scenarios, it may be necessary to transmit an SSB on the SCell. For example, in some standalone deployment scenarios, the SCell may need to transmit an SSB to support synchronization and access by the terminal device. In some complex handover scenarios, transmitting an SSB on the SCell may assist the terminal device in completing inter-cell handover more smoothly.

An SSB may be configured with periodicity, and the network device may periodically transmit the SSB to allow the terminal device to maintain synchronization with the network device or with the serving cell, or to perform cell measurements. However, for the terminal device, since it cannot be guaranteed that each transmitted SSB on the SCell is effectively utilized, this may result in resource waste.

To address this, in higher protocol versions, on-demand transmission of SSBs has been proposed. Such SSBs may be referred to as on-demand SSBs. On-demand SSBs are not transmitted continuously but transmitted only for a specific period of time. For example, on-demand SSBs may include two types. One in which the network device transmits SSBs during a certain time period for terminal devices to perform SSB detection, where the network device may indicate the time period information to the terminal device via control signaling such as RRC signaling or a MAC CE. The other in which the terminal device requests SSB transmission from the network device on demand, and the network device transmits the SSB at the terminal device's request. In this manner, resource waste can be reduced.

In lower protocol versions, the SSB is transmitted periodically. When parameters of the SSB, such as the period, are modified, the network device notifies the terminal device through broadcast signaling. On-demand SSB transmission is not supported by terminal devices operating under lower protocol versions. Since on-demand SSBs need to be transmitted within a specific time period, when on-demand SSB transmission stops or when transmission parameters, such as the transmission period, are modified, terminal devices will assume that the SSB is continuously being transmitted. Even if signaling informs the terminal device that the SSB transmission will cease after a certain time period, this signaling, being part of a higher protocol version, cannot be recognized or interpreted by terminal devices of lower protocol versions. After the SSB transmission is interrupted, terminal devices of lower protocol versions may still mistakenly perform operations such as measurements and synchronization using the SSB, potentially leading to issues in subsequent communications. Specifically, two scenarios may arise.

Firstly, for terminal devices supporting lower protocol versions, when the configuration specifies that no SSB is transmitted on the SCell, and the terminal device is in the RRC_CONNECTED state, while an on-demand SSB is transmitted on the SCell for terminal devices supporting higher protocol versions, the terminal device supporting the lower protocol version will not attempt to detect the on-demand SSB. In this case, when receiving physical layer PDSCH and physical uplink shared channel (PUSCH), the terminal device will not perform rate matching on the SSB during the decoding process, resulting in decoding errors.

Secondly, for terminal devices supporting lower protocol versions, when the SCell of the terminal device is configured as allowing SSB transmission, and the terminal device is in the RRC_IDLE or RRC_INACTIVE state, the terminal device may fail to recognize the cell when attempting to search for the SCell, either during a period with no SSB transmission or when the SSB has not been triggered. This occurs because there is no available SSB to provide the necessary synchronization and system information. However, once the on-demand SSB is triggered, the terminal device may detect the on-demand SSB, recognize the cell, and initiate access. After detecting the on-demand SSB, the terminal device may access the network based on the synchronization signals and system information contained in the on-demand SSB. Once the terminal device enters the RRC_CONNECTED state based on the on-demand SSB, when the network device stops transmitting the on-demand SSB, the terminal device may remain unaware that the on-demand SSB has ceased, thus incorrectly using the on-demand SSB for measurements, which may lead to inaccurate measurement results. One possible solution is that once the terminal device enters the RRC_CONNECTED state, the network device can hand the terminal device over to another cell before the on-demand SSB transmission stops, ensuring that the terminal device maintains its connection and continues to receive service without being impacted by the absence of the on-demand SSB.

However, when terminal devices supporting lower protocol versions access the network through on-demand SSB, and the network device hands the terminal device over to another cell before the on-demand SSB transmission ends, the following issues arise. Firstly, when the on-demand SSB transmission stops, the network device needs to schedule the terminal device, release resources, and reallocate resources for uplink, downlink, and control, which increases the scheduling burden on the network device. Secondly, before the on-demand SSB transmission stops, the terminal device that accessed the network via the on-demand SSB must be switched to the correct cell, which increases the delay before the on-demand SSB can be stopped, and the cell handover process also introduces additional delay. Finally, when switching to a neighboring cell, the terminal device needs to perform measurements and report results. During the measurement process, the communications by the terminal device may be paused, which impacts the quality of user communication. Additionally, frequent measurements and handovers consume the power of the terminal device, especially in NR systems, where the terminal device needs to sweep in all directions, which is time-consuming and energy-draining.

In view of this, in the embodiments of the present application, after the adjustments to the SSB in the higher protocol version relative to the lower protocol version, the CellBarred field in the MIB information is used to prohibit certain terminal devices from accessing the cell, while allowing the desired terminal devices to access the cell.

As shown in Table 1 above, the basic function of the CellBarred field in the MIB information is to control whether terminal devices are allowed to access the cell. Currently, this field can only globally allow or prohibit access for all terminal devices. The embodiments of the present application enable the use of the CellBarred field, combined with more granular control, to restrict access for specific terminal devices, such as terminal devices supporting lower protocol versions, rather than prohibiting access for all terminal devices.

In the case where the MIB information in the SSB indicates that the cell is barred from access, terminal devices supporting lower protocol versions will not access the cell based on this SSB. However, terminal devices supporting higher protocol versions can further determine whether to access the cell based on the relevant content in the MIB information, and will access the cell based on the SSB when access to the cell is allowed. This enables cell access control for terminal devices with different protocol versions. Therefore, terminal devices supporting lower protocol versions will not mistakenly use the SSB intended for terminal devices supporting higher protocol versions for access and measurement, preventing a decrease in communications quality or even connection interruptions in subsequent communications.

FIG. 2 is a schematic flowchart of a communications method according to an embodiment of the present application. The method 200 shown in FIG. 2 may be performed by a terminal device and a network device. The terminal device may be, for example, supports a predetermined protocol version, or supports on-demand SSB. The predetermined protocol version may be, for example, a higher protocol version, such as Release 19 or later in NR. Correspondingly, the terminal device that supports a lower protocol version may be, for example, a terminal device of Release 18 or earlier versions in NR.

As shown in FIG. 2, the method 200 includes part or all of the following steps.

In step 210, the network device transmits an SSB to the terminal device.

Accordingly, in step 220, the terminal device receives the SSB transmitted by the network device.

The SSB includes an MIB, which is used to indicate that the cell is barred from access. The field in the MIB used for indicating that the cell is barred from access may be, for example, the cellBarred field as shown in Table 1 above.

In the embodiments of the present application, when the MIB information in the SSB indicates that the cell is barred from access, terminal devices supporting lower protocol versions will not access the cell. However, even when the MIB information in the received SSB indicates that the cell is barred from access, it is still possible for terminal devices supporting higher protocol versions to access the cell based on the SSB. That is, it is possible for the MIB information to indicate that a cell is barred from access while the SSB is still used by terminal devices to access the cell.

For example, when the MIB information indicates that the cell is barred from access, whether terminal devices supporting higher protocol versions are allowed to access the cell can be further indicated through another field in the MIB, or a combination of one or more other fields within the MIB. These fields in the MIB may be ones that are typically not utilized or only rarely utilized by terminal devices when the cellBarred field indicates that the cell is barred from access. These fields can be used to indicate to terminal devices supporting higher protocol versions whether access to the cell is allowed.

The following describes in detail how a terminal device, upon receiving an SSB carrying MIB information indicating that a cell is barred from access, can determine whether to access the cell. The terminal device referred to in the following description is one that supports a higher protocol version.

### Embodiment 1

In some embodiments, the MIB information includes a first field. The first field is used to indicate whether the SSB is a cell-defined SSB (CD SSB) or a non-cell-defined SSB (NCD SSB). The terminal device may determine whether to access the cell based on the first field.

For example, the first field may be the ssb-SubcarrierOffset field in the MIB information. The ssb-SubcarrierOffset field can be used to indicate whether the SSB is a CD SSB or an NCD SSB. For example, when the value of the ssb-SubcarrierOffset field is in the range of 0 to 14, it indicates that the SSB is a CD SSB. When the value of the ssb-SubcarrierOffset field is 15, it indicates that the SSB is an NCD SSB.

In NR systems, CD SSB and NCD SSB are two types of SSBs. One of the differences between CD SSB and NCD SSB lies in whether they are used for obtaining system information such as SIB1. Specifically, CD SSB is typically used for acquiring system information. The PBCH in a CD SSB includes MIB information, and the MIB information carries the CORESET and search space configuration information used to obtain SIB1. Therefore, the terminal device can acquire SIB1 based on the CD SSB. In contrast, the MIB information carried in the PBCH of an NCD SSB does not contain the configuration information for the PDCCH that carries SIB1. As such, the terminal device cannot obtain system information based on an NCD SSB. The primary role of an NCD SSB is interference cancellation and robustness enhancement. For example, the PSS and SSS may be measured to obtain interference signal strength, and the NCD SSB can also provide timing and synchronization reference, helping the terminal device correctly receive and demodulate signals from the network device. The NCD SSB is not used for transmitting system information. The CD SSB must be transmitted on a synchronization raster, whereas the NCD SSB is not required to be transmitted on a synchronization raster. In other words, the NCD SSB may or may not be transmitted on a synchronization raster.

Here, the terminal device may determine whether to access the cell based on the first field in one of the following three ways. These are described in detail below.

### Embodiment 1-1

In some embodiments, whether to access the cell may be determined based on whether the first field indicates that the SSB is a CD SSB or an NCD SSB. For example, when the first field indicates that the SSB is an NCD SSB, the terminal device does not access the cell. When the first field indicates that the SSB is a CD SSB, the terminal device accesses the cell.

Typically, when the cellBarred field in the MIB information indicates that the cell is barred from access, i.e., the cellBarred field is set to barred, the terminal device is not allowed to access the cell. Therefore, the MIB information may not include information related to SIB1, i.e., the corresponding SSB is an NCD SSB. In other words, it is unlikely that a situation occurs where the cellBarred field is set to barred while the SSB is a CD SSB. Accordingly, this embodiment considers using such a condition to indicate to terminal devices supporting higher protocol versions whether access to the cell is allowed. For terminal devices of lower protocol versions, or for terminal devices that have already accessed the cell, when the cellBarred field in the MIB information is set to barred, it is assumed that the MIB information does not include SIB1 and such terminal devices will not access the cell based on the SSB. However, when the cellBarred field is set to barred, terminal devices supporting higher protocol versions can determine whether access to the cell is allowed based on the first field. For example, when the first field indicates that the SSB is a CD SSB, the terminal device can determine that access to the cell is allowed. Whereas, when the first field indicates that the SSB is an NCD SSB, the terminal device can determine that access is not allowed.

For example, the first field is the ssb-SubcarrierOffset field in the MIB information. When the cellBarred field is set to barred, the terminal device determines based on the value of the ssb-SubcarrierOffset field whether access to the cell is allowed. When the value of the ssb-SubcarrierOffset field falls within the range of 0 to 14, the SSB is CD SSB, and access to the cell is allowed for the terminal device. When the value of the ssb-SubcarrierOffset field is 15, the SSB is an NCD SSB, and access to the cell is prohibited for the terminal device.

### Embodiment 1-2

In some embodiments, the terminal device may determine whether to access the cell based on the value of a first field. For example, when the value of the first field is a preset value or falls within a preset range, the terminal device may access the cell. Otherwise, the terminal device does not access the cell.

The first field may be the ssb-SubcarrierOffset field in the MIB information. In this case, the preset value or the preset range may correspond to part of the values of the ssb-SubcarrierOffset field that are associated with the CD SSB. The preset value or the preset range may be defined by protocol specifications or transmitted by the network device.

For example, considering that the value indicated by the ssb-SubcarrierOffset field ranges from 0 to 15, and that a value of 15 indicates that the SSB is an NCD SSB, the values from 0 to 14 may be divided into two subsets, respectively indicating whether access is allowed or prohibited. For instance, when the value of the ssb-SubcarrierOffset field in the MIB information of the received SSB ranges from 0 to 13, it may indicate that access to the cell is allowed, and the terminal device may access the cell. When the value of the ssb-SubcarrierOffset field is equal to 14, it may indicate that access to the cell is prohibited, and the terminal device will not access the cell.

### Embodiment 1-3

In some embodiments, the terminal device may determine whether to access the cell based on the first field in combination with other fields. For example, when the first field indicates that the SSB is an NCD SSB, the terminal device does not access the cell. When the first field indicates that the SSB is a CD SSB, the terminal device may further determine whether to access the cell based on other fields in the MIB information.

For example, the MIB information further includes a second field. When the first field indicates that the SSB is a CD SSB, the second field is used to indicate whether the terminal device is allowed to access the cell. When the second field indicates that the terminal device is allowed to access the cell, the terminal device may access the cell based on the SSB. When the second field indicates that the terminal device is prohibited from accessing the cell, the terminal device does not access the cell.

Details regarding the second field will be described below.

### Embodiment 2

In Embodiment 2, the terminal device may determine, based on whether the SSB is transmitted on the synchronization raster, whether to access the cell based on the SSB. For example, when the SSB is transmitted outside the synchronization raster, the terminal device does not access the cell. When the SSB is transmitted on the synchronization raster, the terminal device accesses the cell based on the SSB.

In some embodiments, when the SSB is transmitted outside the synchronization raster, the terminal device does not access the cell. When the SSB is transmitted on the synchronization raster, the terminal device further determines based on a first field in the MIB information whether to access the cell. For example, when the SSB is transmitted on the synchronization raster and the first field indicates that the SSB is an NCD SSB, the terminal device does not access the cell. When the first field indicates that the SSB is a CD SSB, the terminal device accesses the cell. In another example, when the SSB is transmitted on the synchronization raster, the terminal device determines based on a value of the first field whether to access the cell. Specifically, when the value of the first field is a preset value or falls within a preset range, the terminal device accesses the cell. Otherwise, the terminal device does not access the cell. In this case, the detailed process by which the terminal device determines, based on the first field when the SSB is transmitted on the synchronization raster, whether to access the cell may refer to the descriptions related to the first field in Embodiment 1 and will not be repeated herein.

Further, in the above-described Embodiments 1 and 2, when the SSB is an NCD SSB or the SSB is transmitted outside the synchronization raster, it indicates that the cell is barred from access by the terminal device. In other embodiments, when the SSB is a CD SSB or the SSB is transmitted on the synchronization raster, the terminal device may further determine, based on a second field in the MIB information, whether the cell is allowed to be accessed.

Several possible implementations of the second field are described below.

In some embodiments, the second field includes other fields from the MIB information, excluding the Intra-frequency Reselection field, such as one or more of the following: the SFN field, the subcarrier spacing (subCarrierSpacingCommon) field, the SSB subcarrier offset (ssb-SubcarrierOffset) field, the PDCCH SIB1 configuration (pdcch-ConfigSIB1) field, the cell barred (CellBarred) field, the intra-frequency reselection field, the DMSR position (dmrs-TypeA-Position) field, and the reserved bit.

It can be understood that when the CellBarred field is set to barred, the terminal device can determine whether to access the cell based on any of the other fields in the MIB information, excluding the Intra-frequency Reselection field, or by combining multiple fields.

As shown in Table 1 above, the Intra-frequency Reselection field can be used to indicate whether the terminal device is allowed to perform intra-frequency reselection. For example, when the CellBarred field is set to barred, when the Intra-frequency Reselection field is set to allowed, it indicates that the terminal device is allowed to perform intra-frequency reselection. When the Intra-frequency Reselection field is set to not allowed, it indicates that the terminal device is not allowed to perform intra-frequency reselection.

Typically, when the CellBarred field in the MIB information indicates that cell access is barred, i.e., when the CellBarred field is set to barred, for terminal devices with lower protocol versions or those already connected to the cell, the Intra-frequency Reselection field in the MIB information can be used to determine whether intra-frequency reselection is possible, while other fields in the MIB information, excluding the Intra-frequency Reselection field, are not useful for these terminal devices. Therefore, in this embodiment, it is considered to use other fields, such as the second field, excluding the Intra-frequency Reselection field, to indicate whether access to the cell is allowed for terminal devices with higher protocol versions in the case of cell access being barred.

By way of example, in some embodiments, the second field includes the pdcch-ConfigSIB1 field in the MIB information, which indicates whether access by the terminal device to the cell is allowed.

As shown in Table 1 above, the pdcch-ConfigSIB1 field can be used to indicate predetermined resource configurations, such as the bandwidth of PDCCH/SIB1, CORESET information, search space, and necessary PDCCH parameters, etc. Here, the pdcch-ConfigSIB1 field can be reused to indicate whether access to the cell is allowed for the terminal device. For example, when the pdcch-ConfigSIB1 field indicates predetermined resource configurations, it signifies that access to the cell is allowed for the terminal device. These predetermined resource configurations can either be defined in the protocol or transmitted by the network device.

By way of example, in some embodiments, the second field includes a reserved field in the MIB information. The reserved field is used to indicate whether access to the cell is allowed for the terminal device. This approach can reduce the impact on the functionality of other fields.

For example, when the reserved field is set to 1, it indicates that access for the terminal device is allowed. When the reserved field is set to 0, it indicates that access for the terminal device is barred. Alternatively, when the reserved field is set to 0, it indicates that access for the terminal device is allowed. When the reserved field is set to 1, it indicates that access for the terminal device is barred.

### Embodiment 3

When the CellBarred field is set to barred, it is also possible not to determine whether access to the cell is allowed based on fields in the MIB information, but instead to use information associated with the MIB information to determine access for the terminal device.

For example, the MIB information is also used to obtain the SIB1, which is used to indicate whether access to the cell is allowed for the terminal device. In other words, the SIB1 information indicates whether access to the cell is allowed for the terminal device.

As described above with reference to FIG. 2, the method embodiments of the present application are detailed. The device embodiments of the present application are described in detail below with reference to FIGS. 3 to 5. It should be understood that the description of the method embodiments corresponds to the description of the device embodiments. Therefore, parts not described in detail can refer to the previously described method embodiments.

FIG. 3 is a schematic diagram of a terminal device according to an embodiment of the present application. As shown in FIG. 3, the terminal device 300 may include a receiving unit 310. The receiving unit 310 is configured to receive an SSB transmitted by a network device, where the SSB includes MIB information. The MIB information is used to indicate that access to the cell is barred, and the SSB is used for the terminal device to access the cell.

In some embodiments, the MIB information includes a first field, which is used to indicate that the SSB is a cell-defined SSB.

In some embodiments, the first field is an SSB subcarrier offset field in the MIB information, and a value of the first field is a preset value or falls within a preset range.

In some embodiments, the SSB is transmitted on a synchronization raster.

In some embodiments, the MIB information includes an SSB subcarrier offset field, which is used to instruct the terminal device to access the cell.

In some embodiments, the MIB information includes a second field, which is used to instruct the terminal device to access the cell.

In some embodiments, the second field is one of the fields in the MIB information excluding the intra-frequency reselection field.

In some embodiments, the fields in the MIB information excluding the intra-frequency reselection field include one or more of the following: an SFN field, a PDCCH SIB1 configuration field, an SSB subcarrier offset field, a DMSR position field, and a reserved field.

In some embodiments, the second field is the PDCCH SIB1 configuration field in the MIB information, and the PDCCH SIB1 configuration field indicates a predetermined resource configuration.

In some embodiments, the second field is a reserved field in the MIB information, and the reserved field indicates a preset value.

In some embodiments, the MIB information is further used to obtain the SIB1, which is used to instruct the terminal device to access the cell.

In some embodiments, the terminal device supports a predetermined protocol version and/or supports on-demand SSB.

In some embodiments, the predetermined protocol version is a Release 19 version of the NR communications protocol.

It can be understood that the receiving unit 310 may, for example, be a transceiver 530. Optionally, the terminal device 300 further includes a processor 510 and a memory 520, as specifically shown in FIG. 5.

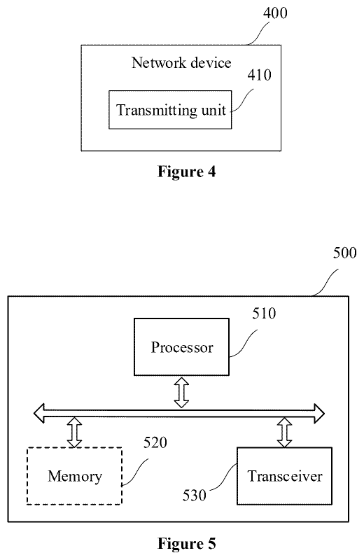

FIG. 4 is a schematic diagram of a network device according to an embodiment of the present application. As shown in FIG. 4, the network device 400 includes a transmitting unit 410. The transmitting unit 410 is configured to transmit an SSB to a terminal device, where the SSB includes MIB information. The MIB information is used to indicate that access to the cell is barred, and the SSB is used for the terminal device to access the cell.

In some embodiments, the MIB information includes a first field, which is used to indicate that the SSB is a cell-defined SSB.

In some embodiments, the first field is an SSB subcarrier offset field in the MIB information, and a value of the first field is a preset value or falls within a preset range.

In some embodiments, the SSB is transmitted on a synchronization raster.

In some embodiments, the MIB information includes an SSB subcarrier offset field, which is used to instruct the terminal device to access the cell.

In some embodiments, the MIB information includes a second field, which is used to instruct the terminal device to access the cell.

In some embodiments, the second field is one of the fields in the MIB information excluding the intra-frequency reselection field.

In some embodiments, the fields in the MIB information excluding the intra-frequency reselection field include one or more of the following: an SFN field, a PDCCH SIB1 configuration field, an SSB subcarrier offset field, a DMSR position field, and a reserved field.

In some embodiments, the second field is the PDCCH SIB1 configuration field in the MIB information, and the PDCCH SIB1 configuration field indicates a predetermined resource configuration.

In some embodiments, the second field is a reserved field in the MIB information, and the reserved field indicates a preset value.

In some embodiments, the MIB information is further used to obtain the SIB1, which is used to instruct the terminal device to access the cell.

In some embodiments, the terminal device supports a predetermined protocol version and/or supports an on-demand SSB.

In some embodiments, the predetermined protocol version is a Release 19 version of the NR communications protocol.

It can be understood that the transmitting unit 410 may, for example, be a transceiver 530. Optionally, the network device 400 further includes a processor 510 and a memory 520, as specifically shown in FIG. 5.

FIG. 5 is a structural diagram of a communications apparatus according to the embodiments of the present application. The dashed lines in FIG. 5 indicate that the unit or module is optional. The apparatus 500 can perform the method described in the aforementioned method embodiments. The apparatus 500 can be a chip, a terminal device, or a network device.

The apparatus 500 may include one or more processors 510. The processor 510 can support the apparatus 500 to perform the method described in the previous method embodiments. The processor 510 can be a general-purpose processor or a dedicated processor. For example, the processor 510 can be a central processing unit (CPU). Alternatively, the processor may also be another general-purpose processor, a digital signal processor (DSP), an application-specific integrated circuit (ASIC), a field-programmable gate arrays (FPGA), or other programmable logic devices, a discrete gate or transistor logic device, a discrete hardware component, etc. A general-purpose processor may be a microprocessor or any conventional processor, etc.

The apparatus 500 may also include one or more memories 520. The memory 520 stores a program that can be executed by the processor 510, causing the processor 510 to perform the method described in the previous method embodiments. The memory 520 can be independent of the processor 510 or integrated within the processor 510.

The apparatus 500 may further include a transceiver 530. The processor 510 can communicate with other devices or chips via the transceiver 530. For example, the processor 510 can transmit date to or receive data from other devices or chips through the transceiver 530.

A communications system is further provided according to an embodiment of the present application. The communications system includes the above-described terminal device and network device. In some implementations, the system further includes other devices that interact with the terminal device and/or the network device.

A computer-readable storage medium for storing a program is further provided according to an embodiment of the present application. The computer-readable storage medium can be applied to the terminal device or the network device in the embodiments of the present application, and the program causes a computer to perform the method performed by the terminal device or the network device as described in the various embodiments of the present application.

A computer program product is further provided according to an embodiment of the present application. The computer program product comprises a program. The computer program product may be applied to the terminal device or the network device in the embodiments of the present application, and the program causes a computer to perform the method performed by the terminal device or the network device as described in the various embodiments of the present application.

A computer program is further provided according to an embodiment of the present application. The computer program may be applied to the terminal device or the network device in the embodiments of the present application, and the computer program causes a computer to perform the method performed by the terminal device or the network device as described in various embodiments of the present application.

It should be understood that the terms “system” and “network” as used in the embodiments of the present application may be used interchangeably. In addition, the terminology used in the present application is only for the purpose of describing specific embodiments, and is not intended to limit the present application. The terms “first,” “second,” “third,” and “fourth,” as used in the specification, claims, and drawings of the present application, are intended to distinguish different objects and are not intended to indicate any particular order. Furthermore, the terms “comprising” and “having,” and any variations thereof, are intended to cover non-exclusive inclusion.

In the embodiments of the present application, the term “indicate” may refer to a direct indication, an indirect indication, or an indication of an association. For example, “A indicates B” may mean that A directly indicates B, such as B being obtainable from A; or that A indirectly indicates B, such as A indicating C and B being obtainable from C; or that A and B have an associated relationship.

In the embodiments of the present application, “B corresponding to A” means that B is associated with A and can be determined based on A. However, it should be understood that determining B based on A does not necessarily mean determining B solely based on A, instead may also be based on A and/or other information.

In the embodiments of the present application, the term “corresponding” may indicate a direct or indirect correspondence, an associative relationship, or a relationship such as indicating and being indicated, configuring and being configured, etc., between two elements.

In the embodiments of the present application, “predefined” or “preconfigured” may be implemented by storing corresponding code, tables, or other mechanisms capable of indicating related information in the device (e.g., including the terminal device and the network device) in advance. The present application does not limit the specific manner of implementation. For example, “predefined” may refer to definition specified in a protocol.

In the embodiments of the present application, the term “and/or” is merely used to describe an association between related objects and represents three possible relationships. For example, “A and/or B” may indicate: A alone, both A and B, or B alone. In addition, the symbol “/” generally indicates an “or” relationship between the associated objects before and after the symbol.

In the embodiments of the present application, the term “include or comprise” may refer to either direct inclusion or indirect inclusion. Optionally, the term “include or comprise” as used in the embodiments of the present application may be replaced with “indicate” or “configured to determine.” For example, “A comprises B” may be replaced with “A indicates B” or “A is configured to determine B.”

In various embodiments of the present application, the numbering of the above processes does not imply any order of execution. The actual order of execution should be determined based on the functions and inherent logic of the processes, and should not be construed as limiting the implementation of the embodiments of the present application.

It should be understood that the disclosed systems, devices, and methods in the embodiments of the present application can be implemented in other ways. For example, the apparatus embodiments described above are merely illustrative. The division of the units is just based on logical functions, and different implementations may adopt other divisions. For instance, multiple units or components may be combined or integrated into another system, some features may be omitted, or may not be executed. Furthermore, the coupling or direct coupling or communications connection between the units shown or discussed can be achieved through interfaces, indirect coupling, or communications connections of the devices or units, which may be electrical, mechanical, or in other forms.

The units described as separate components may or may not be physically separate. The components displayed as units may or may not be physical units, meaning they could be located in one place or distributed across multiple network units. Depending on practical requirements, part or all of the units may be selected to achieve the objectives of the present embodiment.

Additionally, in various embodiments of the present application, the functional units may be integrated into a single processing unit, may physically exist as separate units, or may be integrated into a single unit consisting of two or more units.

The above embodiments can be achieved entirely or partially through software, hardware, firmware, or any combination thereof. When implemented by software, the above embodiments may be entirely or partially realized in the form of a computer program product. The computer program product includes one or more computer instructions. When loaded and executed on a computer, the computer program instructions generate, in whole or in part, the processes or functions described in the embodiments of the present application. The computer can be a general-purpose computer, a special-purpose computer, a computer network, or another programmable device. The computer instructions can be stored in a computer-readable storage medium, or transmitted from one computer-readable storage medium to another. For example, the computer instructions can be transmitted from a website, computer, server, or data center to another website, computer, server, or data center via wired (e.g., a coaxial cable, an optical fiber, or a digital subscriber line (DSL)) or wireless (e.g., infrared, wireless, microwave, etc.) means. The computer-readable storage medium can be any available medium that the computer can read, or a data storage device such as a server or data center that includes one or more available media. The available media may be magnetic media (e.g., a floppy disk, a hard disk, or a magnetic tape), optical media (e.g., a digital video disc (DVD)), or semiconductor media (e.g., a solid-state disk (SSD)), or the like.

The foregoing description is merely illustrative of specific embodiments of the present application, and the scope of protection of the present application is not limited thereto. Any variations or substitutions that can be readily conceived by those skilled in the art within the scope of the disclosed technology of the present application shall fall within the scope of protection of the present application. Therefore, the scope of protection of the present application shall be defined by the claims.

What is claimed is:

1. A communications method, comprising:
receiving, by a terminal device, a synchronization signal/physical broadcast channel block (SSB) from a network device, wherein the SSB comprises main information block (MIB) information, the MIB information indicates that access to a cell is barred; and
accessing the cell based on the SSB.

2. The method according to claim 1, wherein the MIB information comprises a first field, and the first field indicates that the SSB is a cell-defined SSB.

3. The method according to claim 2, wherein the first field is an SSB subcarrier offset field in the MIB information, and a value of the first field is a preset value or within a preset range.

4. The method according to claim 1, wherein the SSB is received on a synchronization raster.

5. The method according to claim 4, wherein the MIB information comprises an SSB subcarrier offset field, and the SSB subcarrier offset field is used to instruct the terminal device to access the cell.

6. The method according to claim 2, wherein the MIB information comprises a second field, and the second field is used to instruct the terminal device to access the cell.

7. The method according to claim 6, wherein the second field is a field other than an inter-frequency reselection field in the MIB information.

8. The method according to claim 7, wherein the field other than the inter-frequency reselection field in the MIB information comprises one or more of:
a system frame number field;
a physical downlink control channel (PDCCH) system information block (SIB1) configuration field;
a subcarrier spacing field;
a DMSR position field; or
a reserved field.

9. The method according to claim 6, wherein the second field is a PDCCH SIB1 configuration field in the MIB information, and the PDCCH SIB1 configuration field indicates a predetermined resource configuration.

10. The method according to claim 6, wherein the second field is a reserved field in the MIB information, and the reserved field indicates a preset value.

11. The method according to claim 1, wherein the MIB information is further used to acquire a SIB1, and the SIB1 is used to instruct the terminal device to access the cell.

12. The method according to claim 1, wherein the terminal device supports at least one of a predetermined protocol version or an on-demand SSB.

13. The method according to claim 12, wherein the predetermined protocol version is a Release 19 version of a new radio (NR) communications protocol.

14. A communications method, comprising:
transmitting, by a network device, a synchronization signal/physical broadcast channel block (SSB), wherein the SSB comprises main information block (MIB) information, the MIB information indicates that access to a cell is barred, and the SSB is used during a process for accessing the cell.

15. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving a synchronization signal/physical broadcast channel block (SSB) from a network device, wherein the SSB comprises main information block (MIB) information, the MIB information indicates that access to a cell is barred; and
accessing the cell based on the SSB.

16. The apparatus according to claim 15, wherein the MIB information comprises a first field, and the first field indicates that the SSB is a cell-defined SSB.

17. The apparatus according to claim 16, wherein the first field is an SSB subcarrier offset field in the MIB information, and a value of the first field is a preset value or within a preset range.

18. The apparatus according to claim 15, wherein the SSB is received on a synchronization raster.

19. The apparatus according to claim 18, wherein the MIB information comprises an SSB subcarrier offset field, and the SSB subcarrier offset field is used to instruct to access the cell.

20. The apparatus according to claim 16, wherein the MIB information comprises a second field, and the second field is used to instruct to access the cell.
